(19) United States
(12) Patent Application Publication
(10) Pub. No.: US 2010/0011138 A1
(43) Pub. Date: Jan. 14, 2010

(54) DESIGN STRUCTURE FOR AUTOMATED MEANS FOR DETERMINING INTERNET ACCESS ON A SYSTEM ON A CHIP

(75) Inventors: Jonathan Phillip Ebbers, Essex Junction, VT (US); Kenneth Joseph Goodnow, Essex, VT (US); Todd Edwin Leonard, Williston, VT (US); Peter Albert Twombly, Shelburne, VT (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: INTERNATIONAL BUSINESS MACHINES CORPORATION, Armonk, NY (US)

(21) Appl. No.: 12/170,166

(22) Filed: Jul. 9, 2008

(51) Int. Cl. G06F 13/14

(52) U.S. Cl. 710/107

(57) ABSTRACT

A method for determining Internet access by an autonomous electronic circuit on a system on a chip integrated circuit includes a system bus which is snooped to determine if Internet activity is occurring on the system bus. Local header information is collected when the snooping has determined that Internet activity is occurring on the system bus. A packet including the local header information is created. Internet access is requested with the created packet.

### BACKGROUND OF THE INVENTION

1. Field of the Invention

The present invention generally relates to a design structure for determining means, and more particularly, to a design structure for determining Internet access on a system on a chip.

2. Description of the Related Art

Conventional integrated circuits are increasingly relying on autonomous functions, or intellectual properties (IP's), provided on the integrated circuit. IP on an integrated circuit may also be referred to as an electronic circuit (EC). Each IP, or EC, may provide a separate function. Increasingly, enough IP's are being provided on to a single integrated circuit, that the resulting integrated circuit may be referred to a system on a chip (SOC). In a SOC, all conventional computer functions are found on one integrated circuit, including a central processing unit (CPU) and Internet access.

As more and more IP functions are being placed on the conventional integrated circuit, the likelihood increases that the manufacturer, designer, or programmer for each IP may be different. As more and more producers contribute a different IP to an integrated circuit, the different IP's become more autonomous. That is, the SOC or integrated circuit designer may rely on a third-party IP design to work properly because the integrated circuit designer cannot hope to account for the operations of each IP on the integrated circuit.

Furthermore, with each IP, it is more and more difficult for the integrated chip designer to completely understand, configure, customize, or program each IP. This difficulty would arise in part because each IP may be provided by a different designer and each IP provides a different function. Primarily, however, this difficulty would arise because a single conventional integrated circuit would have hundreds of different IP's placed on it.

Therefore, the SOC designer has to rely on each autonomous IP to be self-sufficient because the SOC designer cannot account for every IP on the SOC. In order to be more self-sufficient, conventional autonomous IP may require Internet access to become fully configured or to receive updates or commands. That is, conventional IP is becoming more and more “plug and play,” for their integrated circuit designers.

However a problem arises in that each IP cannot be designed with an Internet access protocol, structure, or hardware. Accordingly, a need arises for the conventional autonomous IP to determine and access the Internet without the expensive and unrealistic step for each IP to be configured to access the Internet.

### SUMMARY OF THE INVENTION

In view of the foregoing, and other, exemplary problems, drawbacks, and disadvantages of the conventional systems, it is an exemplary feature of the present invention to include a method for determining Internet access by an autonomous electronic circuit on a system on a chip integrated circuit, the method including snooping on a system bus to determine if Internet activity is occurring on the system bus, collecting local header information when the snooping has determined that Internet activity is occurring on the system bus, creating a packet including the local header information, and requesting Internet access with the created packet.

It is another exemplary feature of the present invention to include a computer-readable medium storing a program for determining Internet access by an autonomous electronic circuit on a system on a chip integrated circuit, the method including snooping on a system bus to determine if Internet activity is occurring on the system bus, collecting local header information when the snooping has determined that Internet activity is occurring on the system bus, creating a packet including the local header information, and requesting Internet access with the created packet.

An additional benefit of the present invention would be to create a solution for how an autonomous piece of IP can connect to the Internet through an unknown Internet access port. In the future the Internet will become even more pervasive and time to market pressures keep increasing, IP will be placed on SOCs without the time to create a complete system.

Likewise, autonomous IP may need the ability to access their development source in order to obtain updates or other information. Thus, the present invention provides an autonomous piece of IP with a method to snoop the data bus and duplicate the data packet in order to send the information to an external Internet location.

An additional benefit of the present invention would be that autonomous IP have the ability to communicate over the Internet. In addition, the SOC designer is not required to devote time, energy, or resources to system setup. Another benefit is that there can be advanced help/problem correcting/status without system designer interaction.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 illustrates an exemplary system on a chip 100 for providing Internet access to autonomous IP;

FIG. 2 illustrates an exemplary method 200 for snooping for Internet access on SOC 100;

FIG. 3 illustrates an exemplary data flow 310 for an EC according to method 200;

FIG. 4 illustrates another exemplary data flow 410 for an EC according to method 200;

FIG. 5 illustrates an exemplary flow diagram 500 of a design process used in semiconductor design, manufacture, and/or test;

FIG. 6 illustrates a typical hardware configuration which may be used for implementing the computer system and method according to the exemplary aspects of the present invention; and

FIG. 7 illustrates a magnetic data storage diskette 700 and CD-ROM 702 which may be used to store instructions for performing the method 200.

### DETAILED DESCRIPTION OF EXEMPLARY EMBODIMENT OF THE INVENTION

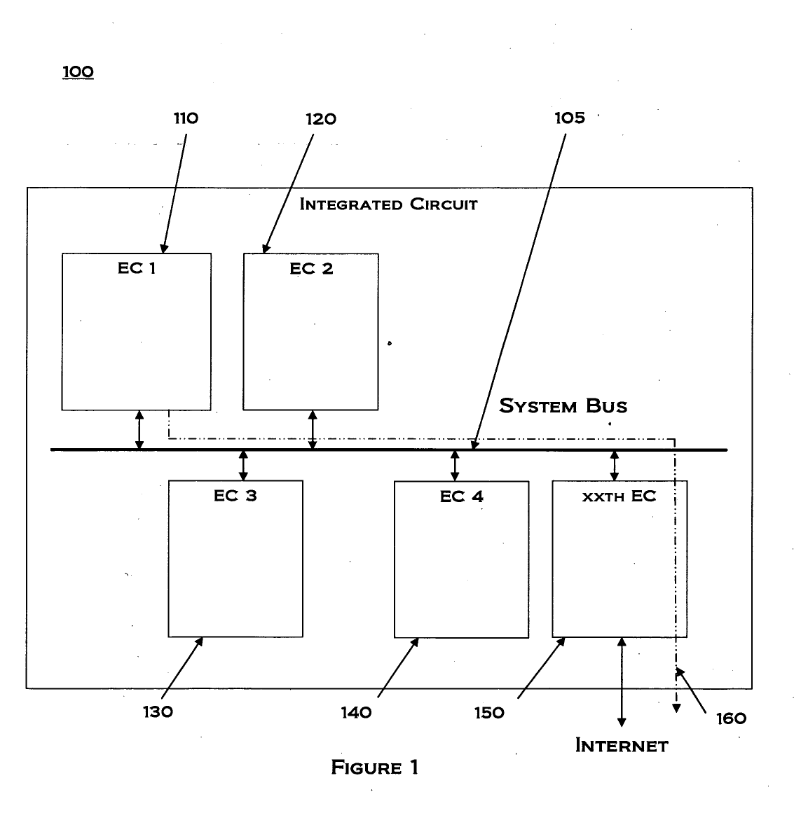

Referring now to the drawings, and more particularly to FIGS. 1-7, there are shown exemplary embodiments of the method and structures according to the present invention.

FIG. 1 illustrates an exemplary system on a chip (SOC) integrated circuit 100. Referring to FIG. 1, SOC 100 would include a plurality of EC's, or IP's. For example, FIG. 1 illustrates that SOC includes first EC 110, second, EC 120, third EC 130, and fourth EC 140 up to XXth EC 150. That is, the XXth EC 150 illustrates that, exemplarily, there may be over a hundred EC's on SOC 100. The plurality of EC's are each exemplarily associated via system bus 105. Each EC may be any configuration of IP or circuitry. Each of the EC's would exemplarily be autonomous.

Nonetheless, each of the autonomous EC's would exemplarily not be provided with Internet access or the systems, hardware, or design to independently or autonomously access the Internet. Nonetheless, each EC may require Internet access to function properly. FIG. 1 illustrates that one of the EC's, XXth EC 150 for example, would be designed to access the Internet. Additionally, first EC 110 is illustrated as having a connection 160 with the Internet through XXth EC 150. That is, one EC on bus 105 may be configured to connect to the Internet through bus 105.

That is, exemplarily, at least one EC or IP on an exemplary system on a chip would have Internet access capabilities. However, because each of the other EC's may not be preprogrammed with the information of where Internet access is to be acquired on SOC 100, an exemplary method would be provided to each EC to find and acquire Internet access through system bus 105.

A piece of IP, that is XXth EC 150, is able to physically access the Internet. For example, XXth EC 150 may consist of both the upper layers and physical tools required for accessing the Internet. Exemplarily, a different device (such as second EC 120) can already be preconfigured to access the Internet by doing a bus write to XXth EC 150 with correct packet information for sending out an Internet request. As part of the packet, the sending EC will know its bus ID and include that bus ID in the packet so that return information can be sent back to the sending EC. This return information could be data, error codes or a completion response. XXth EC 150 would then take the packet and send the packet from the other EC out onto the Internet.

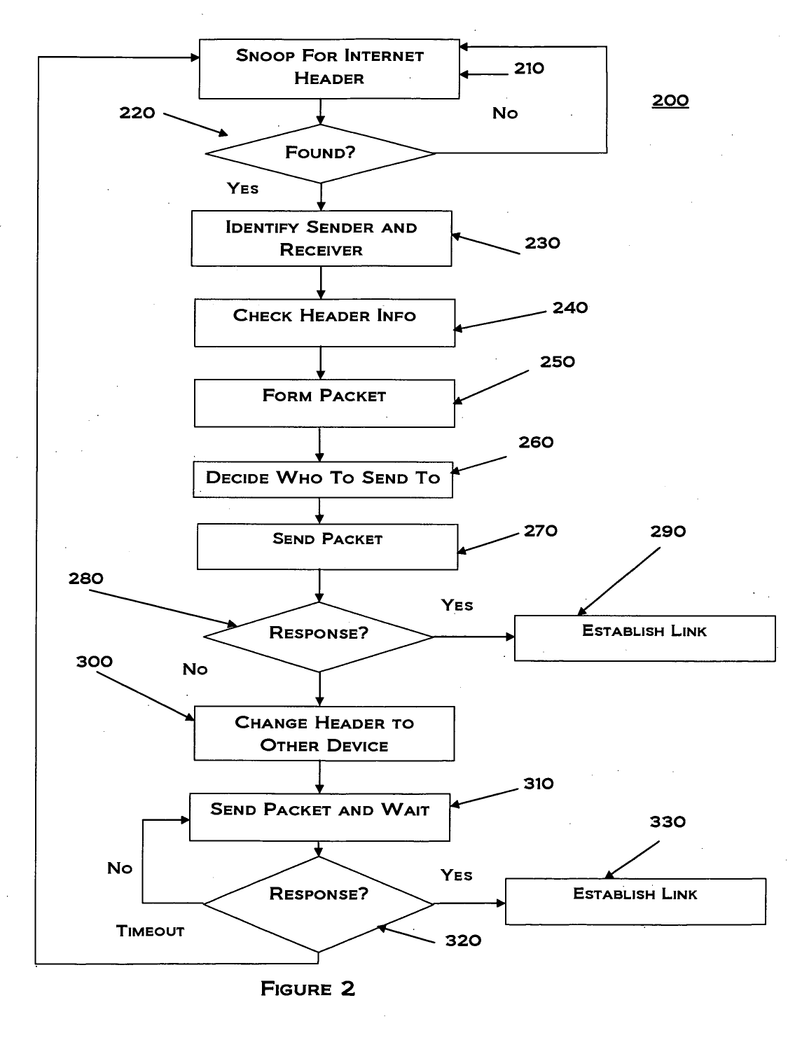

FIG. 2 illustrates an exemplary method 200 for autonomous EC's to access the Internet through other Internet-enabled EC's or IP's on a system on a chip. Referring to FIG. 2, method 200 includes a plurality of steps to access the Internet through a system bus on a system on a chip, such as SOC 100.

Step 210 would exemplarily snoop for an Internet header or other information indicating Internet access. Snooping would include accessing, inspecting, and monitoring system bus 105 of SOC 100, for example. After system bus 105 is accessed, the snooping would exemplarily include monitoring the activity on system bus 105. Exemplary Internet access information could include ASCII data such as: “www,” “http://,” HTML code, an internet protocol address (for example, 9.61.105.109), a transmission control protocol, a packet header, etc. Thus, in Step 210, the electronic traffic on system bus 105 would be monitored for signs of Internet activity.

Accordingly, Step 220 exemplarily determines whether such an electronic signature has been snooped or found. If no Internet access signature has been found by the snooping of Step 210, Step 210 is repeated.

After Internet activity has been snooped, Step 230 would identify the sender and receiver of the Internet activity. Exemplarily, a EC providing or having Internet access would be determined. For example, XXth EC 150 could be identified or first EC 110 (already being configured to access the Internet through XXth EC 150) would also be identified. Step 240 would exemplary check the header information of the Internet activity. Since the sender of the data packet could be either the Internet Access XXth EC 150 or another requesting EC (second EC 120, for example), an EC performing method 200 must decide to whom the information must be sent.

Step 250 would exemplarily form a packet for the EC or IP to access the Internet with. Then Step 260 would exemplarily determine to whom the packet should be sent. That is, in snooping the bus, method 200 would not necessarily be able to discern which of first EC 110 or XXth EC 150 is configured with Internet access capability. Therefore, method 200 would exemplarily decide to which of EC 110 or XXth EC 150 the packet should be sent.

The packet would exemplarily be sent in Step 270. Exemplarily, method 200 would put the packet on the data bus sending it to the selected EC. The selected EC being an EC having Internet access or being configured to access the Internet through another EC as identified in Step 230. That is, Step 260 may decide to send the packet to first EC 110 and the packet would be sent in Step 270.

After sending the packet, Step 280 waits for a response. Exemplarily, Step 280 would wait for a predetermined period of time. If a response is returned, Step 290 would be executed a link to the Internet is established. Because, in the present example, first EC 110 does not actually have its own Internet access, no response is returned.

If no response is returned during the predetermined period of time, Step 300 would exemplarily change the header information to another EC or IP determined to have Internet access. Alternatively, method 200 would simply return to Step 210 and resume snooping. Step 310 would exemplarily then send the packet to the newly selected EC or IP and similarly wait for a response. Thus, in the present example, the packet would then be sent to XXth EC 150.

Step 320 would likewise exemplarily wait for a response for a predetermined period of time. If a response is a returned, method 200 would establish a link in Step 330 or return to Step 210 to continue snooping.

In Step 290 and Step 330, the EC or IP would exemplarily begin communicating through the found EC's to the Internet. This communication would include any activity specified by the designer or programmer of the searching EC.

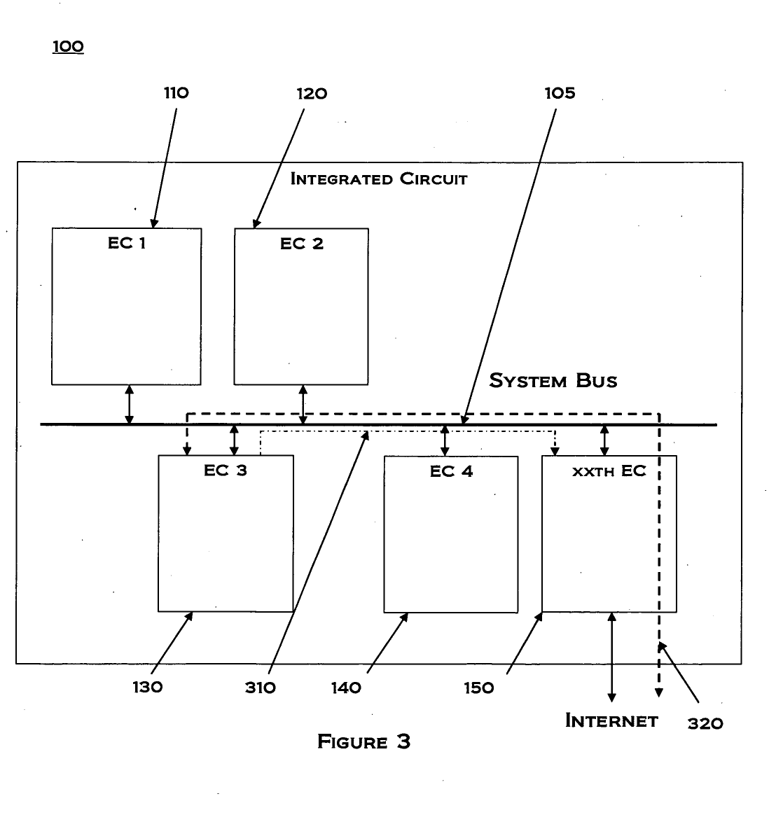

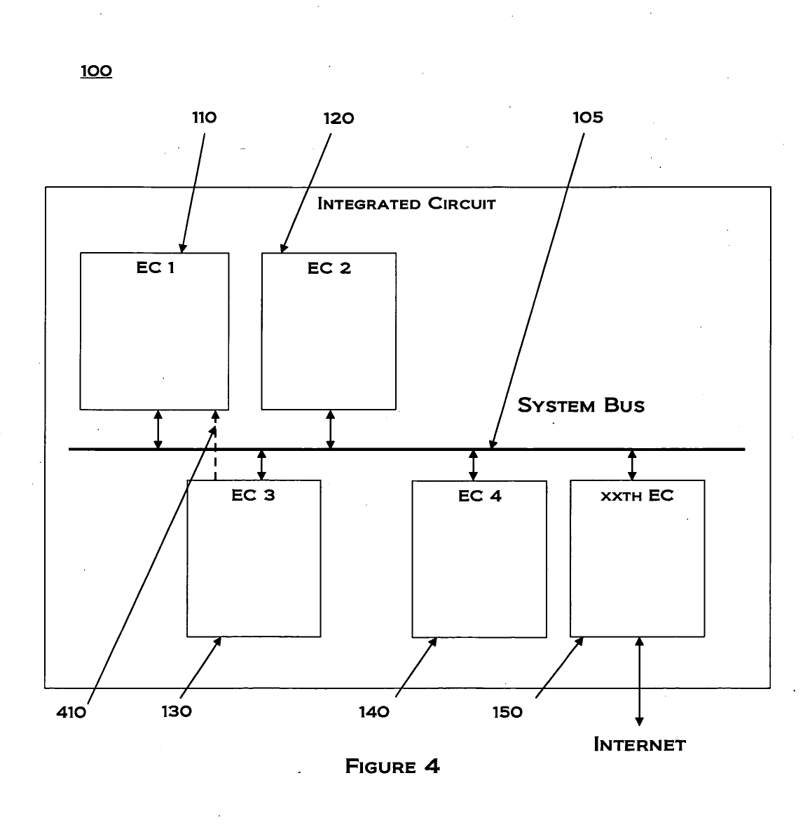

FIGS. 3 and 4 illustrate third EC 130 sending packets to XXth EC 150 and first EC 110, respectively. Referring briefly to FIG. 1, third EC 130 having snooped system bus 105 would exemplarily have discovered the Internet communications of data stream 160. Referring to method 200, the header information would have returned the addresses of first EC 110 and XXth EC 150. Thus, in Step 260, method 200 would decide between sending the packet to first EC 110 and XXth EC 150.

Referring to FIG. 3, in Step 260, EC 110 has decided to send the packet to XXth EC 150 as illustrated by dashed line 310. Data stream 320 illustrates that a response is received and Internet communication has commenced.

Referring to FIG. 4, third EC 130 has instead decided to send the packet to first EC 110. Dashed line 410 illustrates a data stream from third EC 130 to second EC 120. Accordingly, because first EC 110 is exemplarily not designed for or preprogrammed to access the Internet, third EC 130 would not receive a reply. Referring to FIG. 2, Step 280 would exemplarily time out and proceed to Step 300 to change the packet header information.

Exemplarily, method 200 may also wait for multiple packets from multiple EC's to determine the common target bus ID which should be the Internet access point. In addition, once an Internet access point on the system bus is determined, the present invention may also exemplarily memorize these locations for future access. In addition, the method should have the ability to send the packet through multiple levels of protocols.

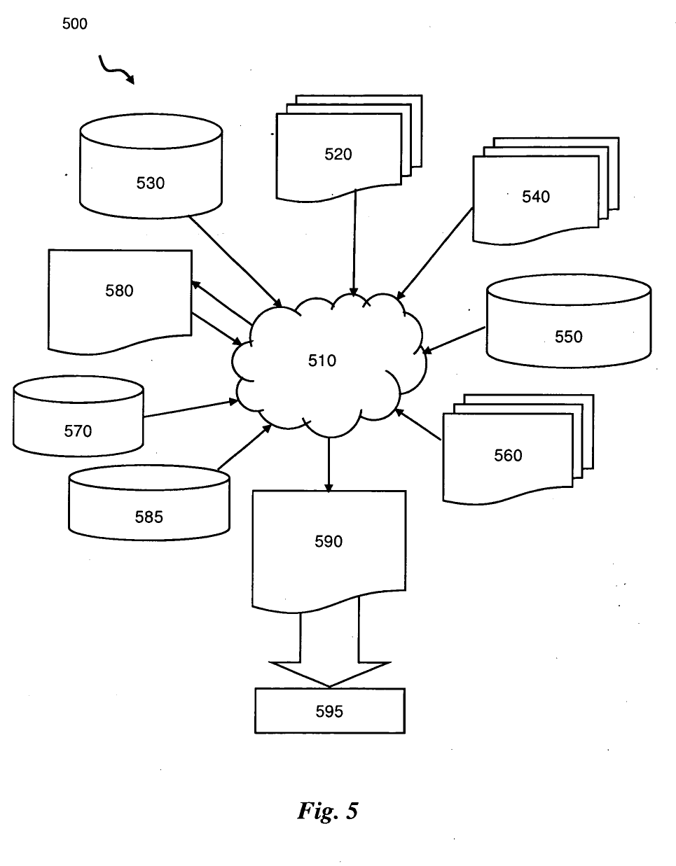

FIG. 5 shows a block diagram of an exemplary design flow 500 used for example, in semiconductor IC logic design, simulation, test, layout, and manufacture. Design flow 500 includes processes and mechanisms for processing design structures or devices to generate logically or otherwise functionally equivalent representations of the design structures and/or devices described above and shown in FIG. 1. The design structures processed and/or generated by design flow 500 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Design flow 500 may vary depending on the type of representation being designed. For example, a design flow 500 for building an application specific IC (ASIC) may differ from a design flow 500 for designing a standard component or from a design flow 500 for instantiating the design into a programmable array, for example a programmable gate array (PGA) or a field programmable gate array (FPGA) offered by Altera® Inc. or Xilinx® Inc.

FIG. 5 illustrates multiple such design structures including an input design structure 520 that is preferably processed by a design process 510. Design structure 520 may be a logical simulation design structure generated and processed by design process 510 to produce a logically equivalent functional representation of a hardware device. Design structure 520 may also or alternatively include data and/or program instructions that when processed by design process 510, generate a functional representation of the physical structure of a hardware device. Whether representing functional and/or structural design features, design structure 520 may be generated using electronic computer-aided design (ECAD) such as implemented by a core developer/designer. When encoded on a machine-readable data transmission, gate array, or storage medium, design structure 520 may be accessed and processed by one or more hardware and/or software modules within design process 510 to simulate or otherwise functionally represent an electronic component, circuit, electronic or logic module, apparatus, device, or system such as those shown in FIG. 1. As such, design structure 520 may include files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 510 preferably employs and incorporates hardware and/or software modules for synthesizing, translating, or otherwise processing a design/simulation functional equivalent of the components, circuits, devices, or logic structures shown in FIGS. 1 and 2 to generate a netlist 580 which may contain design structures such as design structure 520. Netlist 580 may include, for example, compiled or otherwise processed data structures representing a list of wires, discrete components, logic gates, control circuits, I/O devices, models, etc. that describes the connections to other elements and circuits in an integrated circuit design. Netlist 580 may be synthesized using an iterative process in which netlist 580 is resynthesized one or more times depending on design specifications and parameters for the device.

As with other design structure types described herein, netlist 580 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 510 may include hardware and software modules for processing a variety of input data structure types including netlist 580. Such data structure types may reside, for example, within library elements 530 and include a set of commonly used elements, circuits, and devices, including models, layouts, and symbolic representations, for a given manufacturing technology (e.g., different technology nodes, 32 nm, 45 nm, 30 nm, etc.). The data structure types may further include design specifications 540, characterization data 550, verification data 560, design rules 570, and test data files 585 which may include input test patterns, output test results, and other testing information.

Design process 510 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 510 without deviating from the scope and spirit of the invention. Design process 510 may also include modules for performing standard circuit design processes such as timing analysis, verification, design rule checking, place and route operations, etc.

Design process 510 employs and incorporates logic and physical design tools such as HDL compilers and simulation model build tools to process design structure 520 together with some or all of the depicted supporting data structures along with any additional mechanical design or data (if applicable), to generate a second design structure 590. Design structure 590 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures).

Similar to design structure 520, design structure 590 preferably includes one or more files, data structures, or other computer-encoded data or instructions that reside on transmission or data storage media and that when processed by an ECAD system generate a logically or otherwise functionally equivalent form of one or more of the embodiments of the invention shown in FIGS. 1 and 2. In one embodiment, design structure 590 may include a compiled, executable HDL simulation model that functionally simulates the devices shown in FIGS. 1 and 2.

Design structure 590 may also employ a data format used for the exchange of layout data of integrated circuits and/or symbolic data format (e.g. information stored in a GDSII (GDS2), GLI, OASIS, map files, or any other suitable format for storing such design data structures). Design structure 590 may include information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1 and 2. Design structure 590 may then proceed to a stage 595 where, for example, design structure 590: proceeds to tape-out, is released to manufacturing, is released to a mask house, is sent to another design house, is sent back to the customer, etc.

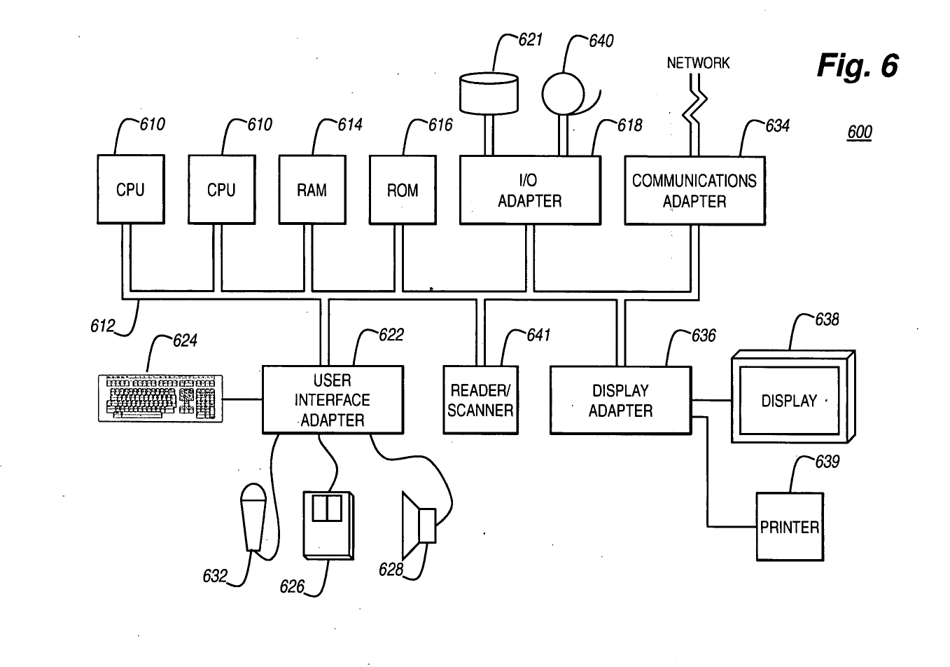

FIG. 6 illustrates a typical hardware configuration which may be used for implementing the computer system and method according to the exemplary aspects of the present invention. The configuration has preferably at least one processor or central processing unit (CPU) 610. The CPUs 610 are interconnected via a system bus 612 to a random access memory (RAM) 614, read-only memory (ROM) 616, input/output (I/O) adapter 618 (for connecting peripheral devices such as disk units 621 and tape drives 640 to the bus 612), user interface adapter 622 (for connecting a keyboard 624, mouse 626, speaker 628, microphone 632, and/or other user interface device to the bus 612), a communication adapter 634 for connecting an information handling system to a data processing network, the Internet, and Intranet, a personal area network (PAN), etc., and a display adapter 636 for connecting the bus 612 to a display device 638 and/or printer 639. Further, an automated reader/scanner 641 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating the CPU 611 to execute a sequence of machine-readable instructions. These instructions may reside in various types of signal bearing media.

Thus, this aspect of the present invention is directed to a programmed product, including signal-bearing media tangibly embodying a program of machine-readable instructions executable by a digital data processor incorporating the CPU 611 and hardware above, to perform the method of the invention.

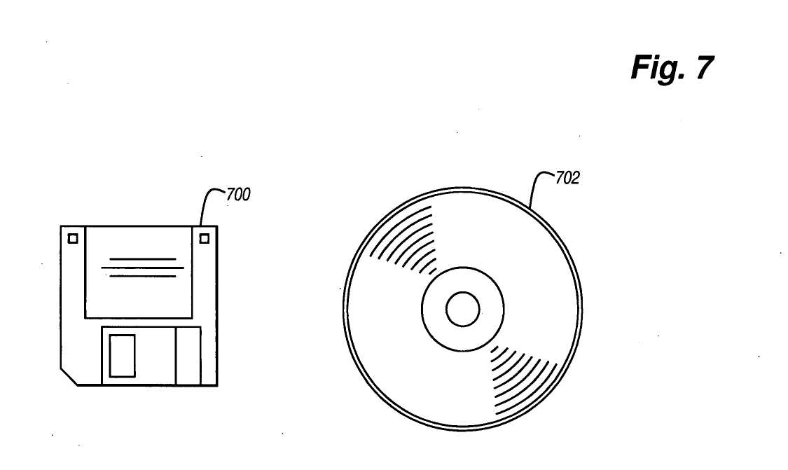

This signal-bearing media may include, for example, a RAM contained within the CPU 611, as represented by the fast-access storage for example. Alternatively, the instructions may be contained in another signal-bearing media, such as a magnetic data storage diskette 700 (FIG. 7), directly or indirectly accessible by the CPU 611.

Whether contained in the computer server/CPU 611, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other tangible signal-bearing media including transmission media such as digital and analog media, and tangible signal-bearing media for communication links and wireless communication. In an illustrative embodiment of the invention, the machine-readable instructions may include software object code, complied from a language such as “C” etc.

While the invention has been described in terms of exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A method of determining Internet access by an autonomous electronic circuit on a system on a chip integrated circuit, the method comprising:
snooping on a system bus to determine if Internet activity is occurring on the system bus;
collecting local header information when the snooping has determined that Internet activity is occurring on the system bus;
creating a packet including the local header information; and
requesting Internet access with the created packet.

2. The method of claim 1, wherein the snooping comprises searching for predefined patterns of data comprising Internet communication.

3. The method of claim 2, wherein the predefined patterns of data comprise one of ASCII data comprising “www,” ASCII data comprising “http://,” HTML code, an internet protocol address, a transmission control protocol, or a packet header.

4. The method of claim 1, further comprising determining an identity of a sender and an identity of a receiver of Internet activity on the system bus.

5. The method of claim 4, further comprising sending a packet to the identified sender of the Internet activity.

6. The method of claim 5, further comprising:
waiting for a response from the sent packet for a predetermined period of time; and
establishing a link with the Internet through the indentified sender when the response is returned.

7. The method of claim 5, further comprising:
waiting for a response from the sent packet for a predetermined period of time;
changing header information to another identified sender; and
sending a packet to the anther identified sender of the Internet activity.

8. The method of claim 7, further comprising establishing a link with the Internet through the indentified sender when a response is returned from the another identified sender.

9. The method of claim 1, further comprising storing collected local header information.

10. A computer-readable medium storing a program for determining Internet access by an autonomous electronic circuit on a system on a chip integrated circuit, said program comprising:
snooping on a system bus to determine if Internet activity is occurring on the system bus;
collecting local header information when the snooping has determined that Internet activity is occurring on the system bus;
creating a packet including the local header information; and
requesting Internet access with the created packet.

11. The computer-readable medium of claim 10, wherein the snooping comprises searching for predefined patterns of data comprising Internet communication.

12. The computer-readable medium of claim 11, wherein the predefined patterns of data comprise one of ASCII data comprising “www,” ASCII data comprising “http://,” HTML code, an internet protocol address, a transmission control protocol, or a packet header.

13. The computer-readable medium of claim 10, further comprising determining an identity of a sender and an identity of a receiver of Internet activity on the system bus.

14. The computer-readable medium of claim 13, further comprising sending a packet to the identified sender of the Internet activity.

15. The computer-readable medium of claim 14, further comprising:
waiting for a response from the sent packet for a predetermined period of time; and
establishing a link with the Internet through the indentified sender when the response is returned.

16. The computer-readable medium of claim 14, further comprising:
waiting for a response from the sent packet for a predetermined period of time;
changing header information to another identified sender; and
sending a packet to the anther identified sender of the Internet activity.

17. The computer-readable medium of claim 16, further comprising establishing a link with the Internet through the indentified sender when a response is returned from the another identified sender.

18. The computer-readable medium of claim 10, further comprising storing collected local header information.
